(19) United States
(12) Patent Application Publication
(10) Pub. No.: US 2017/0030195 A1
(43) Pub. Date: Feb. 2, 2017

(54) METHOD FOR REPAIRING A GAS TURBINE BLADE HAVING AT LEAST ONE CAVITY

(71) Applicant: MTU Aero Engines AG, Munich (DE)

(72) Inventors: Benjamin WALTER, Neustadt am Ruebenberge (DE); Torsten ALBERT, Aerzen (DE); Caesar ORDON, Nordstemmen (DE)

(21) Appl. No.: 15/222,037

(22) Filed: Jul. 28, 2016

(30) Foreign Application Priority Data
Jul. 31, 2015 (DE) 102015214613.8

(51) Int. Cl. F01D 5/00; B23P 6/00; F01D 5/12

(52) U.S. Cl. CPC F01D 5/005; F01D 5/12; B23P 6/002; F05D 2220/32; F05D 2230/10; F05D 2230/30; F05D 2230/80

(57) ABSTRACT

Disclosed is a method of repairing gas turbine blade which has at least one cavity and which has damage in the region of its blade tip, which damage extends through a rim region and a core region of the blade into the at least one cavity. The method comprises at least: a) removing blade material at least in the region of the damage, forming at least one cutaway reaching into the cavity; b) replacing the damaged region by filling the at least one cutaway with a repair material using at least one generative production method; and c) finishing the blade at least in the region of the at least one refilled cutaway. The invention also relates to a gas turbine blade repaired in this manner.

### CROSS-REFERENCE TO RELATED APPLICATIONS

The present application claims priority under 35 U.S.C. §119 of German Patent Application No. 102015214613.8, filed Jul. 31, 2015, the entire disclosure of which is expressly incorporated by reference herein.

### BACKGROUND OF THE INVENTION

1. Field of the Invention

The invention relates to a method of repairing a gas turbine blade which has at least one cavity. The invention also relates to a gas turbine blade repaired using such a method.

2. Discussion of Background Information

Gas turbine blades experience damage during normal operation as a consequence of corrosion and wear, in particular in the region of their blade tips. DE 10 2006 005 364 A1, the entire disclosure of which is incorporated by reference herein, discloses a method in which a gas turbine blade, having superficial damage in the region of its blade tip, is repaired without the repair influencing the core region of the blade in which there is at least one cavity. This involves first removing the damaged region of the blade without damaging the core region. Then, a suitable replacement part is inserted into the cutaway thus formed, and is secured by diffusion welding or diffusion soldering.

In view of the foregoing, it would be advantageous to have available a method permitting rapid and cost-effective repair of a gas turbine blade having damage in the region of its blade tip, wherein the damage extends through a rim region and a core region of the blade into at least one cavity of the blade.

### SUMMARY OF THE INVENTION

The present invention provides a method for repairing a gas turbine blade which has at least one cavity and which has damage in the region of its blade tip, which damage extends through a rim region and a core region of the blade into the at least one cavity. The method comprises:
a) removing blade material at least in the region of the damage, thereby forming at least one cutaway which reaches into the cavity;
b) replacing the damaged region by filling the at least one cutaway with a repair material by using at least one generative production method; and
c) finishing the blade at least in the region of the at least one refilled cutaway.

In one aspect of the method, the blade that is repaired may be a high-pressure turbine blade and/or the damage may be located at least predominantly on just one side of the blade.

In another aspect of the method, the damage may have a length of at most 10 mm (e.g., at most 8 mm) and/or may be located at most 4 mm (e.g., at most 2.54 mm) below a wall underside of the blade tip and/or in a) the blade material may be removed over a length of at most 10 mm (e.g., at most 8 mm) and/or in a) the blade material may be removed up to a distance of at most 4 mm (e.g., at most 2.54 mm) below the wall underside of the blade tip.

In yet another aspect of the method, in a) the blade material may be removed by a chip-removing method, e.g., by milling.

In a still further aspect of the method, prior to b) the blade may be cleaned at least in the region of the cutaway. For example, cleaning may be carried out using a blasting chip-removing method (e.g., using abrasive blasting media) and/or using a grinding method.

In another aspect, the at least one generative production method used in b) may be a deposition welding method. For example, the at least one generative production method used in b) may comprise tungsten inert gas welding (TIG) and/or a laser welding method.

In another aspect of the method, the repair material used may be the blade material and/or at least one material selected from PWA 795, Inconel 617, IN-939, Inconel 625.

In another aspect of the method, c) may comprise the reproduction of an original and/or predetermined blade geometry, at least in the region of the at least one refilled cutaway.

In another aspect, in c) the blade may be finished using a chip-removing method (e.g., a grinding method).

The present invention also provides a gas turbine which has been repaired by using the method set forth above, including the various aspects thereof.

As set forth above, a first aspect of the invention relates to a method for repairing a gas turbine blade which has at least one cavity and which has damage in the region of its blade tip, which damage extends through a rim region and a core region of the blade into the at least one cavity. The method according to the invention comprises at least: a) removing blade material at least in the region of the damage, forming at least one cutaway reaching into the cavity; b) replacing the damaged region by filling the at least one cutaway with a repair material using at least one generative production method; and c) finishing the blade at least in the region of the at least one refilled cutaway. The method according to the invention makes it possible to rapidly and cost-effectively repair blades even as far as the cavity or cavities, wherein at least all of the original wall thickness is rebuilt. The use of a generative production method in step b) also makes it advantageously possible, in contrast to the prior art, to dispense with the production of a precise-fitting replacement part. In addition, the method according to the invention minimizes the risk of damaging the blade during the repair, since—at least in essence —the repair requires only the damaged part of the blade to be machined. In that context, in step b), the at least one cutaway is preferably filled with a quantity of repair material so as to at least reproduce the original contour of the blade. Step c) can in principle encompass one or more steps of the group comprising mechanical machining of the blade surface, cold- and/or heat-treatment of the blade and coating of the blade.

In one advantageous embodiment of the invention, the blade that is repaired is a single-crystal high-pressure turbine blade. This provides particular advantages in terms of time and cost, since hitherto suitable repair methods for high-pressure turbine blades exhibiting damage extending into their cavities were not known.

Further advantages emerge if the damage is located at least predominantly on just one side of the blade. For a single-side repair, it is advantageously not necessary, in the context of the method according to the invention, to completely open the blade from its high-pressure side to its low-pressure side. Instead, it is sufficient to open the blade on one side so as to retain the entire material thickness on the opposite wall of the blade. This also reduces the risk—present hitherto—of causing weld seam sag or the like during the repair. The damaged rim and core region of the blade is reconstructed in its entirety after removal of the defect location, thus reproducing the total material thickness of the previously damaged side wall of the blade.

Further advantages emerge when the damage has a length of at most 10 mm, in particular of at most 8 mm and/or is located at most 4 mm, in particular at most 2.54 mm below a blade tip underside. This ensures that the blade damage which is present in each case reliably permits a “minimally invasive” repair in the context of the present invention. Alternatively or in addition, it is provided that, in a), the blade material is removed over a length of at most 10 mm, in particular of at most 8 mm, and/or that, in a), the blade material is removed up to a distance of at most 4 mm, in particular of at most 2.54 mm below the blade tip underside. This accordingly ensures that the repair is as much as possible restricted to the damaged region of the blade, such that as much undamaged blade material as possible is retained.

In another advantageous embodiment of the invention, it is provided that, in a), the blade material is removed by means of a chip-removing method, in particular by milling. The chip-removing method can be carried out automatically and/or manually. For example, cracks, holes, defects and other damage can be machined using a manual milling machine and/or a pointed milling bit in order to create the cutaway(s) and to shape them as desired for the subsequent build-up step b).

Further advantages emerge when, prior to b), the blade is cleaned, at least in the region of the cutaway. This allows adhering oxides, grinding residues, coating remnants and the like to be quickly and effectively removed from the surface, and as a result the subsequent build-up step b) can be carried out particularly quickly and reliably.

It has been found to be advantageous if cleaning is carried out using a blasting chip-removing method, in particular using abrasive blasting media, and/or using a grinding method. This makes it possible, in a particularly simple manner, to blast or grind the blade back to the bare metal in the region of the cutaway created in step a), rapidly, reliably and without unnecessary removal of material, in order to completely remove any oxide or coating remnants and to ensure a reliable material bond with the repair material.

In another advantageous embodiment of the invention, the generative production method used in step b) is a deposition welding method, in particular tungsten inert gas welding (TIG) and/or a laser welding method. Such free-space methods make it possible to join practically any fusion-weldable materials. A particular advantage of TIG welding is that it does not use a consumable electrode. The addition of filler material and the strength of current are thus decoupled and can be set to optimum levels. The relatively small and spatially restricted input of heat also achieves particularly high weld seam qualities with very little weld distortion. It is accordingly possible, also with laser welding methods, to achieve high welding speeds and narrow and thin weld seam shapes and at the same time little thermal distortion.

An additional increase in the repair quality is achieved, in another embodiment of the invention, when the repair material used is the blade material and/or at least one material of the group PWA 795, Inconel 617, IN-939 and Inconel 625.

Further advantages emerge when c) comprises the reproduction of an original and/or predetermined blade geometry, at least in the region of the at least one refilled cutaway. This particularly reliably reproduces the original aerodynamic properties of the blade.

In that context, it has proven advantageous when, in c), the blade is finished using a chip-removing method, in particular using a grinding method. This represents a particularly quick and simple possibility for finishing the blade in order to bring the latter into the desired shape by removing excess blade material or repair material.

A second aspect of the invention relates to a blade for a gas turbine, which is repaired with a method according to the first aspect of the invention. The features emerging herefrom and their advantages can be gathered from the descriptions of the first aspect of the invention.

Additional features of the invention will emerge from the claims and the exemplary embodiments. The features and combinations of features specified in the above description, and the features and combinations of features specified below in the exemplary embodiments and/or depicted in isolation, can be used not only in the combination indicated in each case, but can also be used in other combinations or in isolation, without departing from the scope of the invention. Thus, embodiments of the invention that are not shown and explained explicitly in the exemplary embodiments, but proceed from and can be created by separate combinations of features from the stated embodiments, should also be considered to have been included and disclosed. In addition, embodiments and combinations of features that therefore do not have all of the features of an originally formulated independent claim should also be considered to have been disclosed.

### BRIEF DESCRIPTION OF THE DRAWINGS

In the drawings:

FIG. 1 shows a schematic perspective view of a blade of a gas turbine that exhibits damage in the region of its blade tip;

FIG. 2 shows a schematic lateral section view of the damaged region of the blade, blade material having been removed forming a cutaway that extends into a cavity;

FIG. 3 shows a schematic section view of the damaged blade;

FIG. 4 shows an enlarged schematic section view of the blade in the region of its damaged blade tip;

FIG. 5 shows a schematic perspective view of the blade in the region of its damaged blade tip;

FIG. 6 shows a perspective view of the blade in the region of its damaged blade tip, the cutaway extending into the cavity being visible;

FIG. 7 shows a perspective section view of the blade; and

FIG. 8 shows another schematic section view of the blade in the region of its blade tip.

### DETAILED DESCRIPTION OF EMBODIMENTS OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show details of the present invention in more detail than is necessary for the fundamental understanding of the present invention, the description in combination with the drawings making apparent to those of skill in the art how the several forms of the present invention may be embodied in practice.

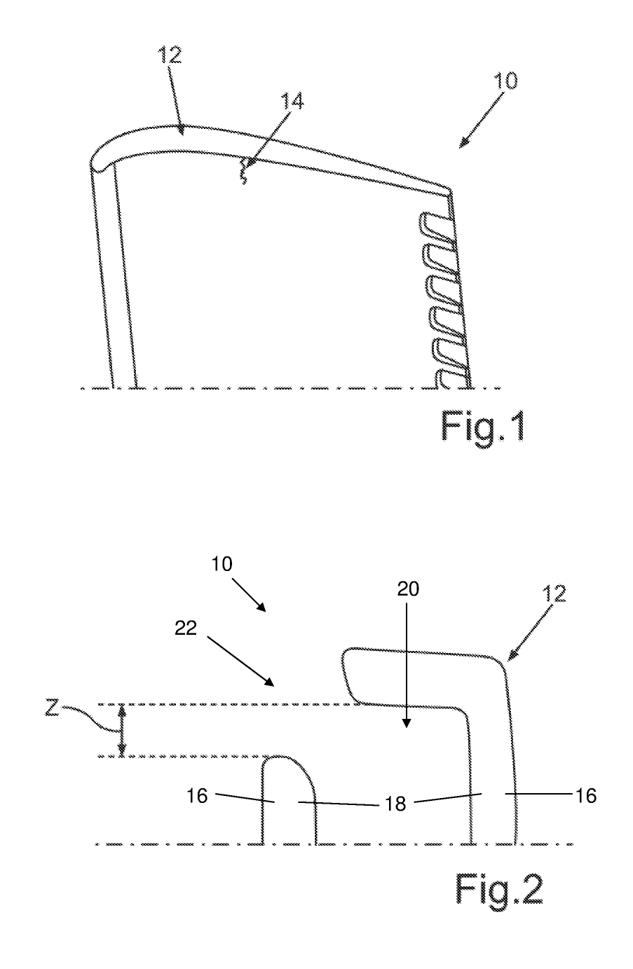

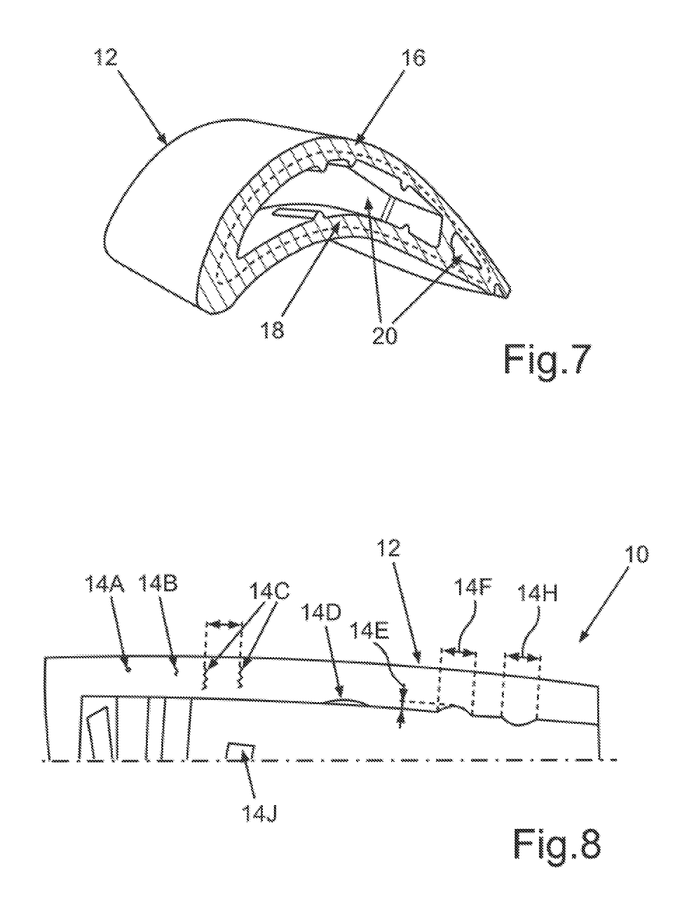

FIG. 1 shows a schematic perspective view of a blade 10, in the present case in the form of a high-pressure turbine blade, of a gas turbine. The blade 10 exhibits, in the region of its blade tip 12, damage 14 which extends through a rim region 16 (see FIG. 2 to FIG. 5) or a wall and possibly through a core region 18 (see FIG. 7) of the blade 10, into a cavity 20 that is in the form of an air channel. The damage 14 can for example be a crack or a defect, other possible types of damage being explained in the context of FIG. 8.

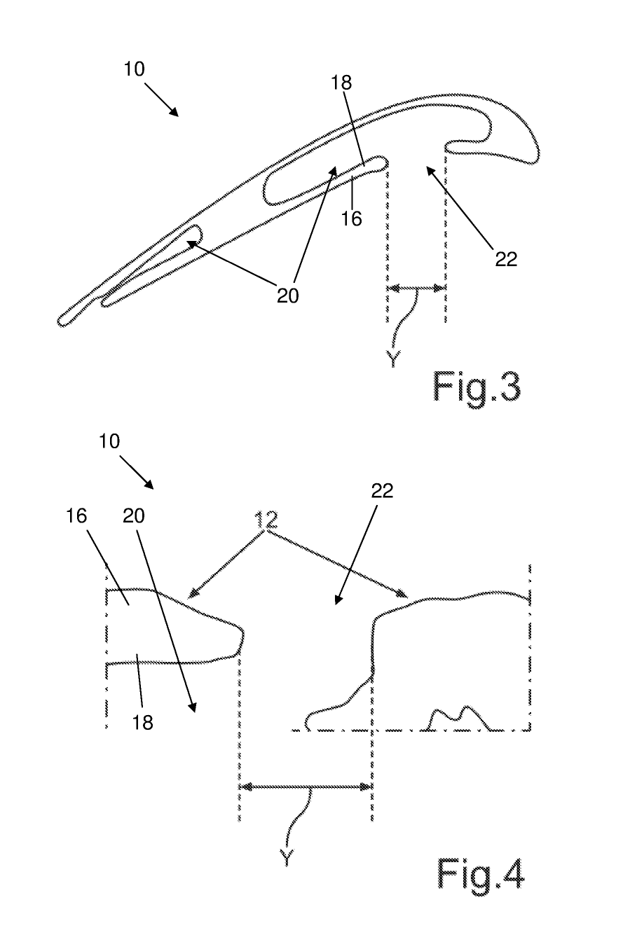

In order to repair the blade 10, blade material is removed at least in the region of the damage 14, forming at least one cutaway 22 that extends into the cavity 20. Removal of the blade material can for example be performed by manual milling using a milling head preferably having a diameter of at most 3 mm, and/or using a pointed milling bit. In this context, FIG. 2 shows a schematic lateral section view of the damaged region of the blade 10, showing the cutaway 22 that extends into the cavity 20 on one side. FIG. 3 shows, for further clarification, a schematic section view of the damaged blade 10, while FIG. 4 shows an enlarged schematic section view of the blade 10 in the region of its damaged blade tip 12. It can be seen that the damage 14 that is to be repaired is on just one side of the blade 10, is at most 8 mm long (reference sign Y in FIG. 3 and FIG. 4) and is at most approximately from 2.54 mm to 4 mm below an underside of the blade tip 12 (reference sign Z in FIG. 2).

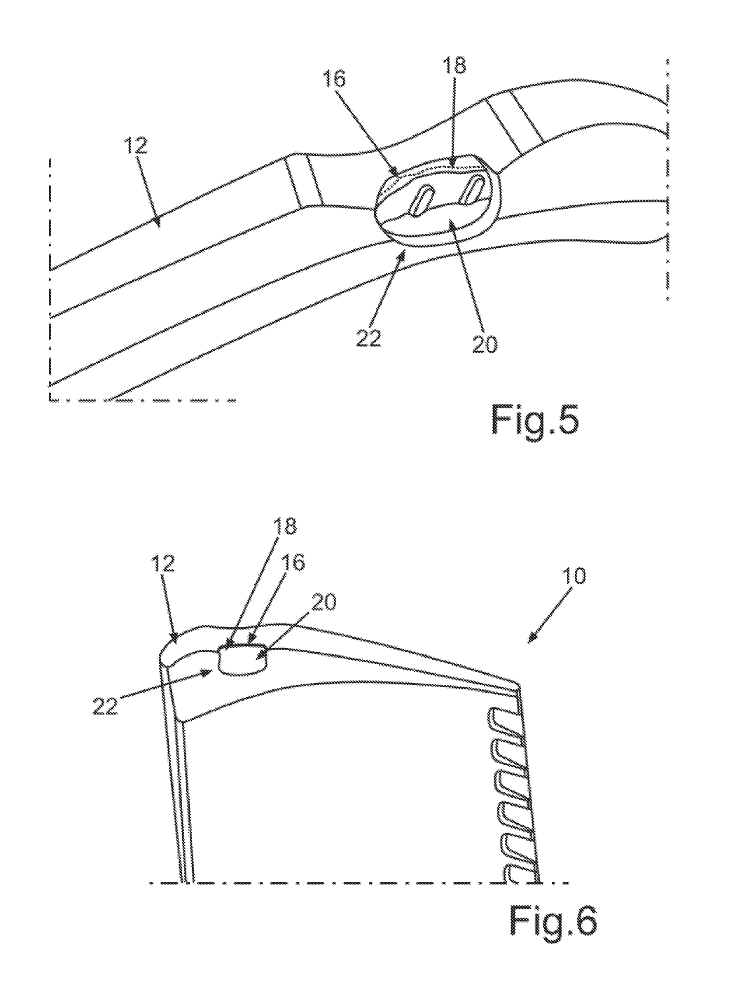

FIG. 5 shows a schematic perspective view of the blade 10 in the region of its damaged blade tip 12, with the cutaway 22 that extends into the cavity 20. As can be seen in FIG. 5, in the present exemplary embodiment the cutaway 22 should also be at most 8 mm long and be at most 2.54 mm below the internal wall of the underside of the blade tip 12, that is to say approximately at most 3.5 mm below the external wall of the blade tip 12. Of course, it is in principle also possible to create two or more cutaways 22.

FIG. 6 shows, for further clarification, a perspective view of the blade 10 in the region of its damaged blade tip 12, the cutaway 22 extending into the cavity 20 being visible.

FIG. 7 shows a perspective section view of the blade 10. Visible in particular are the rim region 16 and the core region 18 of the blade 12, and cavities 20 that are located inside the blade 12 and can be at least partially separated from one another by partitions.

FIG. 8 shows another schematic section view of the blade 10 in the region of its blade tip 12, different types of damage being marked with the reference signs 14A to 14J. The damage 14 that can be repaired with the aid of the method according to the invention includes:
14A pores;
14B small cracks;
14C large cracks;
14D bonding defects;
14E insufficient material;
14F insufficient material;
14H seam sag; and
14J inclusions.

All of the types of damage that can be repaired with the aid of the method according to the invention are for example at most 8 mm long and are arranged at most 2.54 mm below an underside of the blade tip 12.

After creation of the cutaway(s) 22, the region of the cutaway 22 can, in an entirely optional step, be cleaned in order to reliably remove adhering oxides, coatings and the like. To that end, the region of the cutaway 22 can for example be machined by blasting with abrasive silicon carbide particles. In the process, preferably only the region of the cutaway 22, and no adjacent region of the blade 10, is machined, in order to avoid unnecessary loss of material or damage to the blade 10.

Alternatively or in addition, the region of the cutaway 22 can be ground back to the bare metal, use being able to be made for this, for example, of a mounted wheel and/or a grinding belt.

Then, the blade tip 12 is reconstructed by generative means. To that end, the cutaway 22 is for example filled by manual deposition welding (TIG welding) and the missing wall thickness is reconstructed. Use can be made, as repair material or filler material, of PWA 795, for example. Alternatively or in addition, the cutaway 22 can also be at least partially filled by laser welding. Preferably, when filling the cutaway 22, there is created a certain outward excess of material which is then ground back in order to reproduce the original contour of the blade 10. There can also be provided that the blade 10 is subjected to heat- and/or cold-treatment, and/or is coated. This permits rapid, simple and cost-effective repair of blades 10 or hollow blades exhibiting damage on one side, since the damage 14 can be repaired in a “minimally invasive” manner, retaining as much as possible of the undamaged blade materials.

### LIST OF REFERENCE SIGNS

10 Blade
12 Blade tip
14 Damage
16 Rim region
18 Core region
20 Cavity
22 Cutaway

What is claimed is:

1. A method for repairing a gas turbine blade which has at least one cavity and which has damage in a region of its blade tip, which damage extends through a rim region and a core region of the blade into the at least one cavity, wherein the method comprises:
d) removing blade material at least in a region of the damage, forming at least one cutaway reaching into the cavity;
e) replacing the damaged region by filling the at least one cutaway with a repair material using at least one generative production method; and
f) finishing the blade at least in a region of the at least one refilled cutaway.

2. The method of claim 1, wherein the blade that is repaired is a high-pressure turbine blade.

3. The method of claim 1, wherein the damage is located at least predominantly on just one side of the blade.

4. The method of claim 1, wherein the damage has a length of at most 10 mm and/or is located at most 4 mm below a wall underside of the blade tip and/or wherein in a) the blade material is removed over a length of at most 10 mm and/or wherein in a) the blade material is removed up to a distance of at most 4 mm below the wall underside of the blade tip.

5. The method of claim 4, wherein the damage has a length of at most 8 mm and/or is located at most 2.54 mm below a wall underside of the blade tip, and/or wherein, in a), the blade material is removed over a length of at most 8 mm, and/or wherein in a) the blade material is removed up to a distance of at most 2.54 mm below the wall underside of the blade tip.

6. The method of claim 1, wherein the damage has a length of at most 8 mm.

7. The method of claim 6, wherein the damage is located at most 2.54 mm below a wall underside of the blade tip.

8. The method of claim 1, wherein in a) the blade material is removed by a chip-removing method.

9. The method of claim 9, wherein in a) the blade material is removed by milling.

10. The method of claim 1, wherein prior to b) the blade is cleaned at least in the region of the cutaway.

11. The method of claim 10, wherein cleaning is carried out using a blasting chip-removing method and/or using a grinding method.

12. The method of claim 10, wherein cleaning is carried out using abrasive blasting media.

13. The method of claim 1, wherein the at least one generative production method used in b) comprises a deposition welding method.

14. The method of claim 1, wherein the at least one generative production method used in b) comprises tungsten inert gas welding (TIG) and/or a laser welding method.

15. The method of claim 1, wherein the repair material used is the blade material and/or at least one material selected from PWA 795, Inconel 617, IN-939, Inconel 625.

16. The method of claim 15, wherein the repair material comprises at least one material selected from PWA 795, Inconel 617, IN-939, Inconel 625.

17. The method of claim 1, wherein c) comprises a reproduction of an original and/or predetermined blade geometry, at least in the region of the at least one refilled cutaway.

18. The method of claim 1, wherein in c) the blade is finished using a chip-removing method.

19. The method of claim 1, wherein in c) the blade is finished using a grinding method.

20. A blade for a gas turbine, wherein the blade has been repaired by using the method of claim 1.
